(19) United States
(12) Patent Application Publication
(10) Pub. No.: US 2026/0095198 A1
(43) Pub. Date: Apr. 2, 2026

(54) Dynamic Antenna Tuning

(71) Applicant: Apple Inc., Cupertino, CA (US)

(72) Inventors: Vishwanth Kamala Govindaraju, Mountain View, CA (US); Liming Xuan, Beijing (CN); Madhukar K. Shanbhag, Santa Clara, CA (US); Nan Zhang, Santa Clara, CA (US); Sanjeevi Balasubramanian, San Jose, CA (US); Shiva Krishna Narra, San Jose, CA (US); Sriram Subramanian, San Jose, CA (US); Sunil A. Dowray, San Jose, CA (US); Thomas E. Biedka, San Jose, CA (US); Vijay Gadde, San Jose, CA (US)

(21) Appl. No.: 18/900,567

(22) Filed: Sep. 27, 2024

(51) Int. Cl. H04B 1/04; H04B 1/18; H04B 17/336; H04W 72/0453; H04W 72/542

(52) U.S. Cl. CPC H04B 1/0458; H04B 1/18; H04W 72/0453; H04W 72/542; H04B 17/336

(57) ABSTRACT

Disclosed are methods, systems, and computer-readable medium to perform operations including: determining an element of contextual information associated with a user equipment (UE) while the UE is wirelessly connected with a base station; selecting a first tuner state based at least on the element of contextual information; and generating one or more instructions that cause a change to the first tuner state of a first antenna of the UE while the UE is wirelessly connected to the base station.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP) or IEEE 802.11. Some example wireless communication networks include IEEE 802.11bn, Long Term Evolution (LTE), and Fifth Generation New Radio (5G NR). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

In accordance with some aspects of the present disclosure, a method can include determining an element of contextual information associated with a user equipment (UE) while the UE is wirelessly connected with a base station; selecting a first tuner state based at least on the element of contextual information; and generating one or more instructions that cause a change to the first tuner state of a first antenna of the UE while the UE is wirelessly connected to the base station.

In some implementations, selecting the first tuner state can include: determining, for the first antenna and using the element of contextual information, a target operation frequency band having a likelihood of improving an aspect of communication for the UE that satisfies a likelihood threshold; and identifying the first tuner state based at least on the target operation frequency.

In some implementations, determining the target operation frequency can include: providing at least the element of contextual information to an artificial intelligence (AI) model as input; and receiving, from the AI model, an indication of the target operation frequency band having the likelihood of improving the aspect of communication for the UE that satisfies the likelihood threshold.

In some implementations, the UE can include at least a second antenna separate from the first antenna.

In some implementations, the method can include determining, for the second antenna, a respective second tuner state for communication with the base station; and generating instructions to cause the second antenna to change to the respective second tuner state while the UE is wirelessly connected to the base station.

In some implementations, the respective second tuner state for the second antenna can differ from the first tuner state for the first antenna.

In some implementations, selecting the first tuner state can include: determining, for a communication band associated with the first antenna, a traffic type corresponding to data transmitted using the communication band; determining whether the traffic type satisfies a traffic type condition; and identifying, while the UE is wirelessly connected to the base station, the first tuner state based at least on whether the traffic type satisfies the traffic type condition.

In some implementations, selecting the first tuner state can include: determining, for a communication band associated with the first antenna, a likelihood that changing a property of the communication band will change an efficiency of communication using the communication band; and identifying, while the UE is wirelessly connected to the base station, the first tuner state based at least on the likelihood that changing the property of the communication band will change the efficiency of communication using the communication band.

In some implementations, the property of the communication band can be at least one of a bandwidth of the communication band, a signal to noise ratio associated with the communication band, or a channel quality indicator associated with the communication band.

In some implementations, selecting the first tuner state can include: determining a likelihood that changing a property of the first antenna will change an efficiency of communication using the communication band; and identifying the first tuner state for communication with the base station based at least on the likelihood that changing the property of the first antenna will change the efficiency of communication using the communication band exceeding a likelihood threshold.

In some implementations, the property can be at least one of a bandwidth part associated with the first antenna or a number of layers associated with the first antenna. The efficiency can be predicted in decibels for a reference signal received power.

In some implementations, selecting the first tuner state can be based at least on data indicating: a carrier component bandwidth; a scheduling rate associated with a communication band; an application currently executing on the UE; downlink and/or uplink communication occurring at the UE; whether uplink signaling will begin on the UE within a threshold period of time; whether a physical downlink control channel (“PDCCH”) decode associated with a component carrier will begin within a threshold period of time; or a radio resource control.

In some implementations, the method can include determining that a predetermined amount of time has passed since sending the instructions to the first antenna; and resetting the first antenna to a default state.

In some implementations, the method can include determining, using at least second contextual information for the UE and while the UE is wirelessly connected to a second base station, whether to use another tuner state other than the default state for communication with the second base station.

In some implementations, selecting the first tuner state can include selecting, by the baseband processor, the first tuner state.

A system, e.g., a base station, an apparatus including one or more baseband processors, and so forth, can be configured to perform particular operations or actions by virtue of having software, firmware, hardware, or any combination of them installed on the system that in operation causes or cause the system to perform the actions.

The subject matter described in this specification can be implemented in various implementations and may result in one or more of the following advantages. In some implementations, the systems and methods described in this specification can improve wireless device resource usage, e.g., improve communication efficiency using a selected band for a tuner state, reduce power usage, increase transfer rates, or any combination of two or more of these.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network.

FIG. 2 depicts an example environment for dynamically tuning an antenna of a user equipment (“UE”).

FIG. 3 depicts an example user equipment (“UE”).

FIG. 4 depicts an example graph for CQI/SNR based tuning.

FIG. 5 depicts an example environment of tuning states for four bands.

FIG. 6 depicts an example process for CQI/SNR based tuning.

FIG. 7 depicts an example of an environment in which multiple bands are assigned different bandwidths.

FIG. 8 depicts an example process for configuring a cell band using a bandwidth factor (“BWF”).

FIG. 9 depicts an example environment for rank-based tuning.

FIG. 10 depicts an example environment for UE rank-based tuner state selection.

FIG. 11 depicts an example process for selecting a tuner state using network scheduling information.

FIG. 12 illustrates a flowchart of an example method for changing an antenna tuner state.

FIG. 13 illustrates an example UE.

FIG. 14 illustrates an example access node.

### DETAILED DESCRIPTION

Wireless devices, e.g., user equipments (“UEs”), can communicate with other devices, e.g., base stations. As a wireless device communicates using more bands, the antennas included in the wireless device can use any of these bands for wireless communication. When an antenna has a fixed tuner state for the bands it uses, e.g., after the device is sold or otherwise acquired by an end user, the antenna is unable to adjust, e.g., improve, the communications using these bands. For instance, at any particular time, one band might have more bandwidth than another band and the tuner state might not account for this. This can occur more frequently with the use of component carriers (“CCs”) than with one or more other types of communications.

To enable the wireless device to dynamically change tuner states, and thereby improve performance of the wireless device, the wireless device can use contextual information to select a tuner state. The tuner state of an antenna can be changed while the wireless device is wirelessly coupled (e.g., communicating) with another device, e.g., a base station. Since the wireless device can dynamically change a tuner state, the wireless device can more likely account for one or more inefficiencies in a band, reduce power usage, or both.

The contextual information can be any appropriate contextual information associated with the wireless device. For instance, the contextual information can include one or more of data indicating one or more applications executing on the wireless device; data indicating one or more types of transmissions being made, e.g., uplink (“UL”), downlink (“DL”), or both; data indicating one or more UL signals that are about to trigger; data indicating whether a physical downlink control channel (“PDCCH”) decode on a particular CC is expected to start within a threshold time; a channel quality indicator (“CQI”); a signal-to-noise ratio (“SNR”); an amount of bandwidth available on a band; a number of layers available for communication; a base station schedule; any other such transmission/reception related values; or any combination of two or more of these.

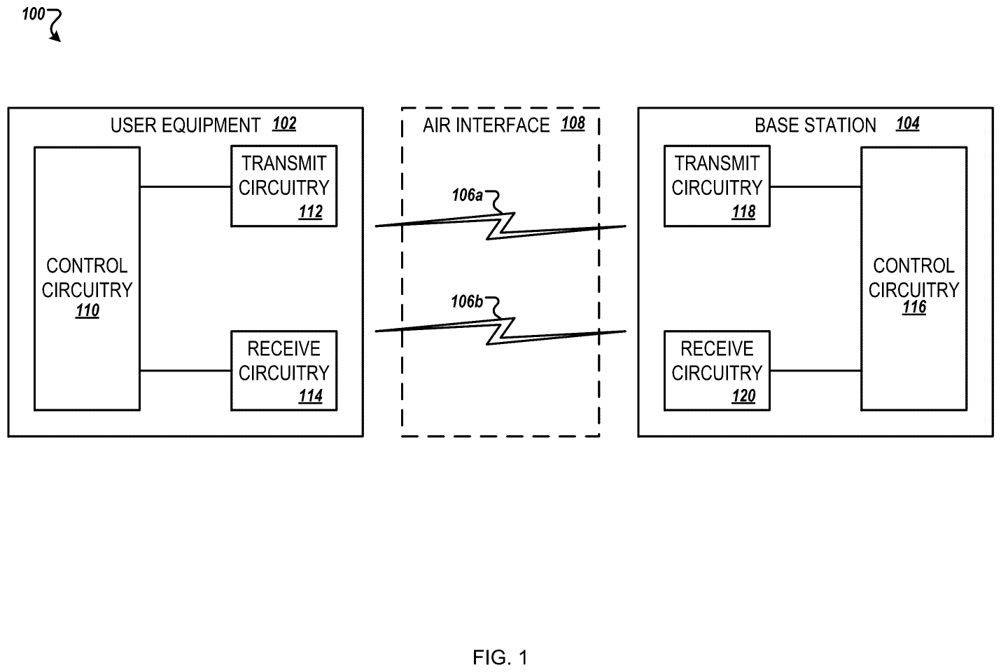

FIG. 1 illustrates a wireless network 100. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards, as defined by Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network, e.g., that incorporates only 5G NR. Furthermore, wireless networks implementing one or more other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of a laptop computer, smartphone, tablet computer, machine-type device (such as smart meter or specialized device for healthcare), intelligent transportation system, or any other wireless device. In network 100, the base station 104 provides the UE 102 network connectivity to a broader network (not shown). This UE 102 connectivity is provided via the air interface 108 in a base station service area provided by the base station 104. In some implementations, such as a broader network may be a wide area network operated by a cellular network provider or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry. The radio frequency circuitry can include a tuner.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For instance, the control circuitry 110 can determine a tuner state, generate instructions to cause a change in tuner state, send instructions to cause a tuner state change, perform one or more other appropriate actions, or any combination of two or more of these.

The transmit circuitry 112 can perform various operations described in this specification. For example, the transmit circuitry 112 can send data, e.g., UL data, to a base station. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations along with carrier aggregation. The transmit circuitry 112 may be configured to receive block data from the control circuitry 110 for transmission on the air interface 108.

The receive circuitry 114 can perform various operations described in this specification. For instance, the receive circuitry 114 can receive data, e.g., DL data, from a base station. Additionally, the receive circuitry 114 may receive one or more signals on a plurality of multiplexed downlink physical channels from the air interface 108 and relay the one or more signals to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, LTE protocol, Advanced Long Term Evolution (LTE-A) protocol, LTE-based access to unlicensed spectrum (LTE-U) protocol, 5G NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

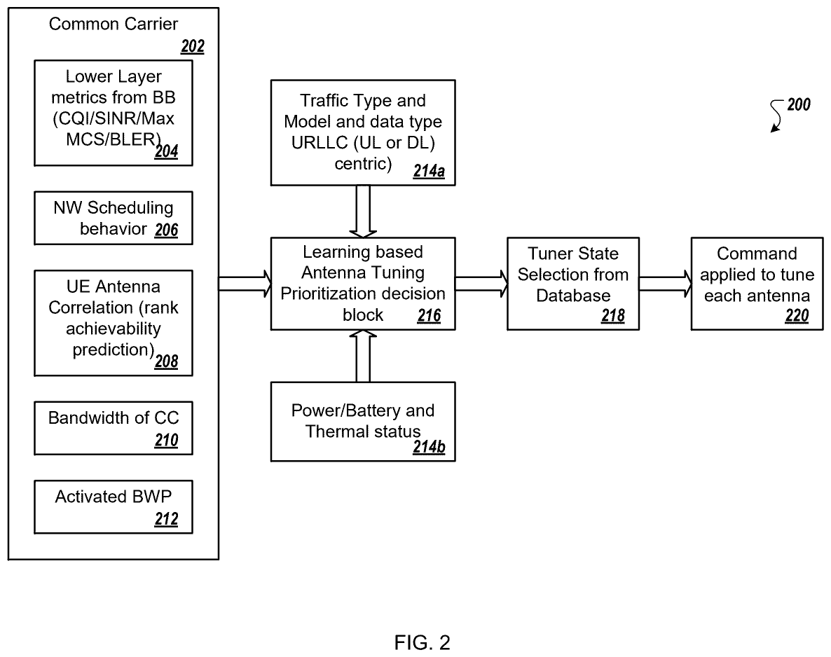

FIG. 2 depicts an example environment 200 for dynamically tuning an antenna of a UE. A device, e.g., a baseband process or another appropriate component or components of a UE, can receive one or more inputs. The inputs can be, e.g., any appropriate type of inputs, for a common carrier 202. For instance, the inputs can include one or more lower layer metrics from baseband physical layer 204, e.g., channel quality indicator (“CQI”), signal-to-noise ratio (“SNR”), signal-to-interference plus noise ratio (“SINR”), max modulation and coding scheme (“MCS”), block error rate (“BLER”), or any combination of these. The inputs can include a network scheduling behavior 206, e.g., of a base station. The inputs can include a UE antenna correlation 208, e.g., a rank achievability prediction. A higher rank for the antenna correlation can indicate a higher input for the antenna. The inputs can include a bandwidth 210 of the common carrier. The inputs can include an activated bandwidth part (“BWP”). The inputs can include a radio resource control (“RRC”). The inputs can indicate whether any PDCCH decode on a particular common carrier is expected to start within a threshold duration, e.g., from a current time. One or more of the inputs can be specific to a particular common carrier. In some implementations, the inputs can include separate values for different common carriers.

In some implementations, the inputs can include data specific to the UE 214a-b. For instance, the inputs can include data about one or more applications installed or executing on the UE. The one or more inputs can include traffic type data 214a. The one or more inputs can include traffic data that indicates if an application is currently receiving data, sending data, or both, e.g., if an application currently running is a DL heavy (or intensive) application, a UL heavy (or intensive) application, or both. The one or more inputs can indicate whether any UL signaling will trigger within a threshold duration, e.g., from a current time. The one or more inputs can indicate a model of the UE. The one or more inputs can indicate whether the UE, e.g., an application executing on the UE, requires ultra reliable and low latency communications (“URLLC”). The one or more inputs can indicate a power status 214b, a battery status, or both. The one or more inputs can indicate a thermal status 214b of the UE.

An antenna tuning block 216 can receive one or more of the inputs. The antenna tuning block 216 can determine a target frequency band of operation, or a band combination, for an antenna in the UE, e.g., for each antenna in the UE. In some implementations, the antenna tuning block can determine the target frequency band of operation based at least on one or more of the inputs.

The device, e.g., the baseband processor, can select a tuner state from a database 218. The device can select the tuner state for a preferred (e.g., offering improved performance) frequency band from a preexisting tuner state database. The database 218 can include, e.g., for the device, a mapping of target frequency operation bands to tuner states. The database can be specific to the UE, to the model of the UE, to the brand of the UE, a class of the UE, components of the UE, etc.

The device commands an antenna to tune to the selected tuning state 220. For instance, the device applies the tuner state for the specific frequency band or band combination to an antenna based at least on the decision from the antenna tuning block 216. In some implementations, the device commands two or more antennas from multiple antennas in the UE, e.g., each antenna, to tune to the corresponding selected tuner state, e.g., when a tuner state is selected for each of the two or more antennas. When tuning two or more antennas to corresponding selected tuner states, at least some of the tuner states can be different from the other tuner states.

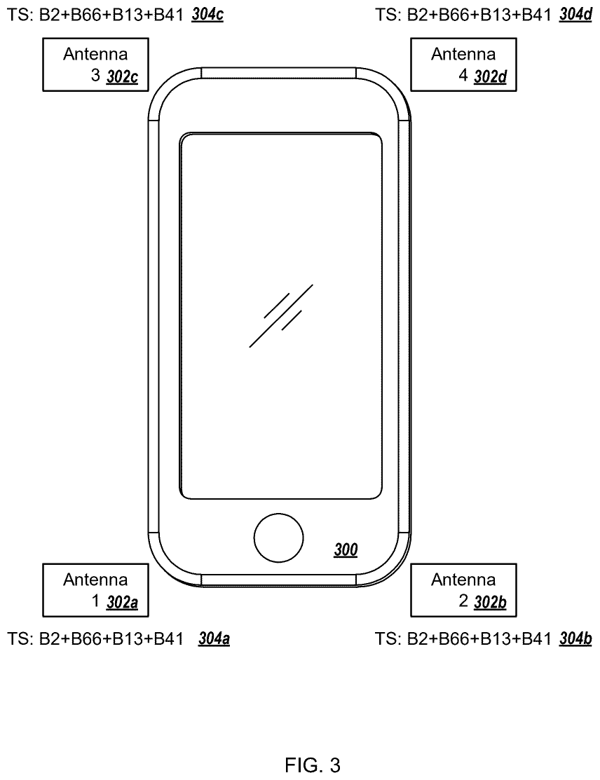

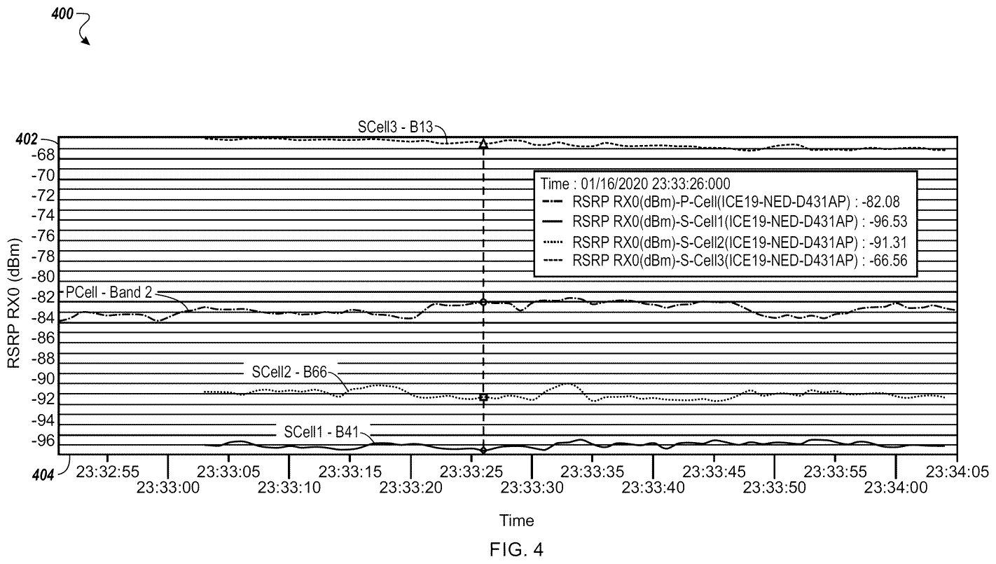

FIG. 3 depicts an example UE 300. FIG. 4 depicts an example graph 400 for CQI/SNR based tuning. In FIG. 3, the UE 300 includes four antennas 302a-d, labeled 1-4. Each of the antennas 302a-d has a corresponding tuning state (“TS”) 304a-d. Here, the tuning states 304a-d are configured to use bands (“B”) 2, 66, 13, and 41.

For a co-located carrier aggregation (“CA”) cell, the UE 300 can experience a different reference signal received power (“RSRP”) value on one band relative to another band due to, e.g., the path loss characteristic of the band. The UE 300 can report a corresponding CQI value for a band, e.g., based on SNR buckets and a mobility state for the RSRP value.

In the example shown in FIG. 4, the UE 300 has a better RSRP, represented by the y-axis 402, across time, represented by the x-axis 404, for B13 compared to B2, B66, and B41. In some implementations, the UE 300 can report the same or substantially the same CQI when the RSRP for a band satisfies an RSRP threshold. For instance, the UE 300 can report the same CQI value for B13 even when the RSRP drops, e.g., by 10 dB, when in a good cell condition, as the SNR might still support a higher MCS. Since the UE 300 can report the same or a substantially similar CQI even when there is a change, e.g., decrease, in the RSRP, the UE 300, or one or more components in the UE 300, can change the tuner state to enhance the RSRP performance of B2, B66 and/or B41.

This change can enable the UE 300 to achieve higher performance on any/all of the other three CA cells, e.g., for B2, B66, and B41. In some implementations, by selecting and improving the bands that do not satisfy the RSRP threshold, the UE 300 can reduce a possibility of over modifying tuners for a band that already has a higher link budget, e.g., as further modification likely will not improve overall data communication for the UE 300. By selecting and improving the bands that do not satisfy the RSRP threshold, the UE 300 can focus on improving efficiency on one or more bands with a higher path loss. As a result, the UE 300 can increase overall communication efficiency, such as improving throughput and/or reducing errors.

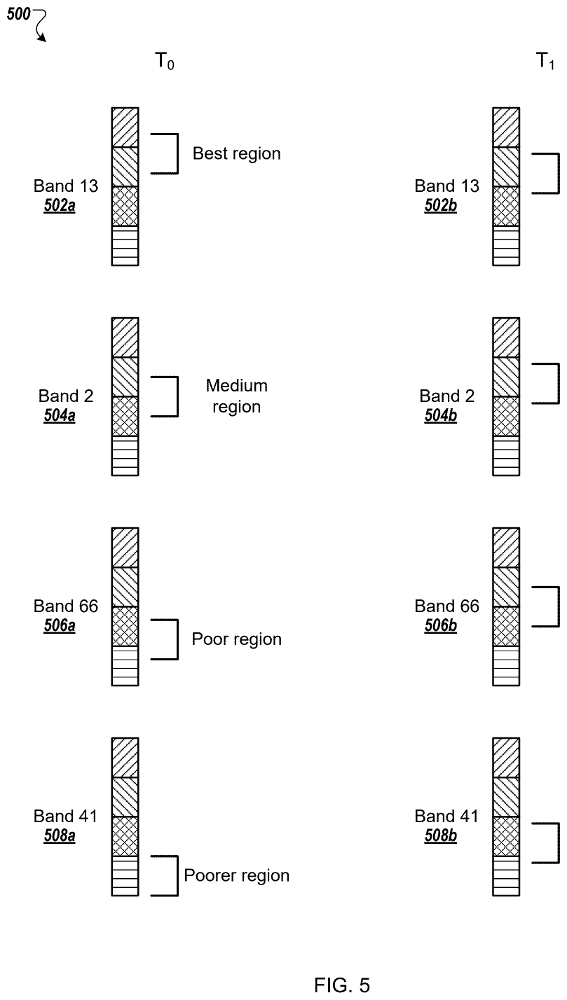

FIG. 5 depicts an example environment 500 of tuning states for four bands 502-508. During a first time period T₀, e.g., an initial time period, a first band B13 502a has the best performance region, a second band B2 504a has a medium performance region, a third band B66 506a has a poor performance region, and a fourth band B41 has a poorer performance region.

By using one or more operations described throughout this specification, e.g., with respect to FIGS. 3-4 above, the UE can improve performance with respect to at least one of the four bands 502-508. For instance, when the first band B13 502b has an RSRP that satisfies the RSRP threshold, the UE can deprioritize the efficiency of the first band B13 502b to have a lower efficiency, as represented by the instance of the first band B13 502b during time period T1. The efficiency of the first band B13 502b can, in some implementations, still satisfy the RSRP threshold during time period T1.

The UE can improve the performance of the second through the fourth bands 504b, 506b, and 508b. For instance, the UE can implement one or more additional tuner states, so that bands with higher bandwidth, scheduling, or both, have a higher efficiency. As a result, the overall bandwidth available to the UE for communications can increase.

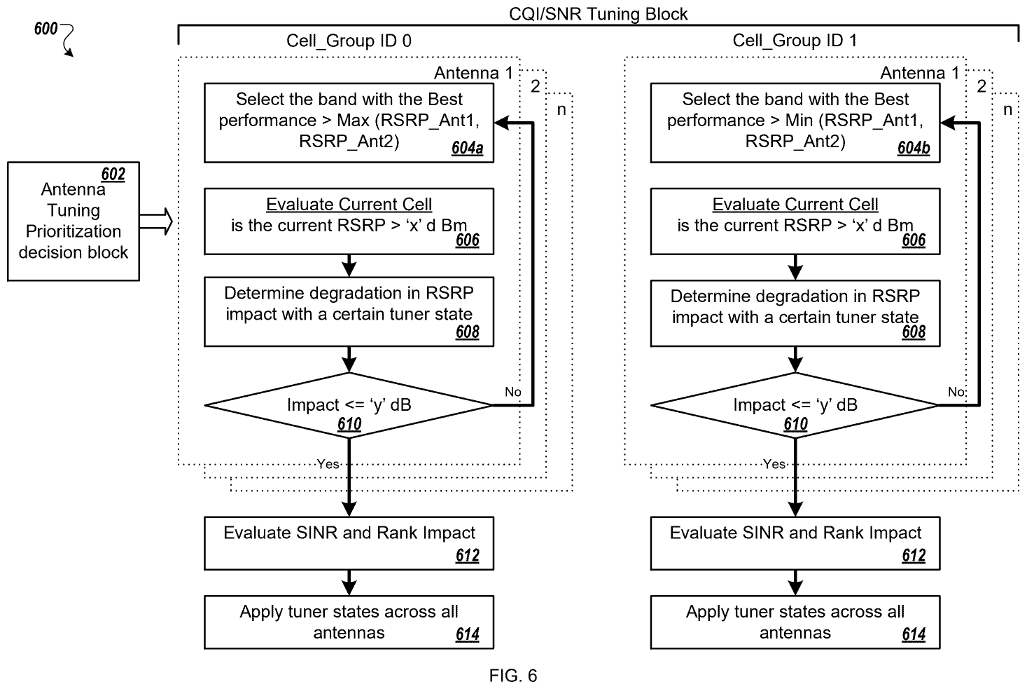

FIG. 6 depicts an example process 600 for CQI/SNR based tuning. The process 600 can be performed by any appropriate device, e.g., the UE 300 or a baseband processor (or equivalent components) in the UE 300. The process 600 can include receiving data from the antenna tuning block 602.

The process 600 can be performed on an antenna basis, a cell group basis, or both. For instance, the process 600 can determine whether there are a group of cells that share similar RSRP values, e.g., above configured threshold such as the RSRP threshold.

The process 600 can select a first cell with signal performance that satisfies a threshold 604a-b, e.g., a highest current performance with respect to one or more metrics. The signal performance can be a performance that is greater than a first predetermined value, e.g., the greatest RSRP for a set of antennas, such as all antennas in the UE or multiple antennas in the UE, e.g., as shown in operation 604a. The signal performance can be a performance that is greater than a second predetermined value, e.g., the minimum RSRP for a set of antennas, such as all antennas in the UE or multiple antennas in the UE, e.g., as shown in operation 604b. In some implementations, this operation can be a safeguard mechanism to deprioritize the efficiency of an antenna if the threshold is satisfied. The process 600 can determine to skip deprioritizing the efficiency of an antenna if the signal is not satisfied. The threshold can be selected to indicate that the corresponding band is within a threshold distance, e.g., at or greater than, one or more saturated cell conditions.

The process 600 can determine a type of tuner state adjustment to perform. The one or more adjustments can degrade efficiency or improve efficiency of the corresponding tuner. For instance, the process 600 can evaluate 606 a current cell's RSRP to determine whether it is greater than the RSRP threshold x decibel-milliwatts (dBm). If so, the process 600 can determine to degrade the current cell's efficiency. If not, the process 600 can determine to improve the current cell's efficiency.

In some implementations, the process 600 can determine 608 a change in RSRP impact for a tuner state. The process 600 can determine this change in RSRP impact given adjustments to a set of tuner values for the tuner state. Given the set of tuner state value adjustments, the process 600 can determine how much a UE's communication efficiency is predicted to change, and the RSRP impact that efficiency change might have on the overall communication performance for the UE. The process 600 can determine 610 whether the RSRP impact satisfies an efficiency threshold, e.g., y in decibels (dB). For instance, the process 600 can determine to target a certain efficiency for improvement and understand if the degradation of the selected cell is within ‘y’ dB. In some implementations, the process 600 can degrade the selected cell up-to ‘y’ dB and check for improvement in one or more other cells.

The process 600 can evaluate 612 the SINR or SNR and Rank impact of the change. For instance, the process 600 can determine whether the change increased, decreased, or had substantially no impact on the UE's communication performance. In some implementations, the process 600 can help in an overall performance improvement by increasing the overall efficiency of the antenna tuner states, bands, or both.

The process 600 can apply the tuner states across one or more antennas in the UE, e.g., across some or all antennas. For instance, when the earlier operations 604 through 612 are simulated or otherwise tested without being applied, applied to only a proper subset of multiple antennas in the UE, or both, the UE can apply the tuner states across one or more of the remaining antennas.

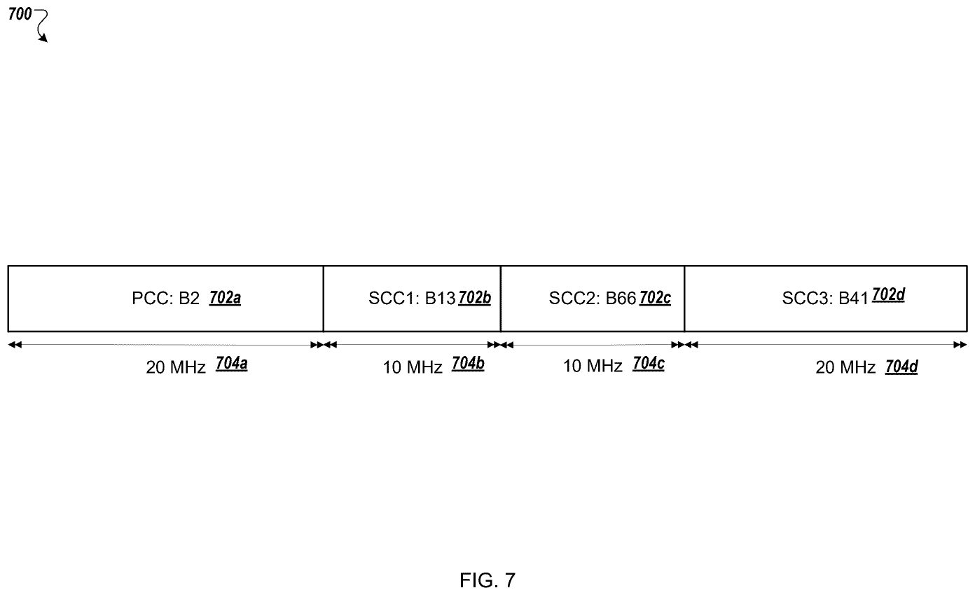

FIG. 7 depicts an example of an environment 700 in which multiple bands 702a-d are assigned different bandwidths 704a-d, respectively. For any given multi-carrier combination, e.g., CA or E-UTRA-new radio dual connectivity (“ENDC”), different component carriers can have different bandwidths, e.g., configured for the respective band 702a-d for the component carrier. If a tuner setting is considered for a given multi-carrier combination irrespective of bandwidth associated with the component carrier, the UE might not have improved (or optimized) communication for the component carrier.

In FIG. 7, the environment 700 includes a carrier aggregation combination of a first band B2 702a, a second band B13 702b, a third band B66 702c, and a fourth band B41 702d. The first band B2 702a is the primary component carrier and is configured with 20 MHz bandwidth (“BW”). The second band B13 702b is the first secondary component carrier (“SCC1”) and is configured with 10 MHz BW. The third band B66 702c is configured with 10 MHz BW and is the second secondary component carrier (“SCC2”). The fourth band B41 702d is configured with 20 MHz BW and is the third secondary component carrier (“SCC3”). The BW configurations can differ in other implementations and can reflect any appropriate BW for a given protocol.

To improve communication for the UE, the UE, e.g., the baseband processor, can use an amount of bandwidth for the respective component carrier when selecting a tuner state. For instance, the UE can use an algorithm in which one or more antennas in the UE are tuned for multi-carrier combinations based at least upon the BW configuration of the component carriers. This can give higher prominence to one or more component carriers with higher BW, increasing network throughput for the UE. In some implementations, the UE can use an algorithm that considers any MAC control elements (“CEs”) based bandwidth part (“BWP”) activation causing the UE to receive data on a lower BW. If such an event occurs during an active data connection, the algorithm can consider the activated BWP as the BW of the band. In some implementations, the UE can use an algorithm that increases a likelihood that a primary cell (“PCell”), any signaling link, or both, will not be detuned in mid to far cell conditions to allow the successful transfer of signaling data. For instance, if any UL signaling is to be sent, the algorithm can enable enhanced tuning on the band for the UL signaling so that critical data is handled efficiently. In some implementations, the UE can use an algorithm that detunes a band, e.g., decreases the efficiency of the band, if the new tuner table for the UE causes an impact that satisfies an impact threshold, e.g., causes low or medium impact to the band. The impact threshold can be, e.g., between 10 to 20%, selected given the applications executing on or presented on the UE, e.g., applications for which the UE receives user input. The impact can satisfy the impact threshold when the impact is less than, equal to, or either, the impact threshold. If the new tuner table causes an impact that does not satisfy the impact threshold, e.g., a large impact to the band, the UE can determine to skip detuning the band. The impact might not satisfy the impact threshold when the impact is greater than, equal to, or either, the impact threshold.

Table 1, below, shows an example of a bandwidth-based tuner configuration, e.g., determined on a per component carrier basis by the base station. Table 2, below, shows an example of bandwidth factors for the tuner configuration. For instance, Table 2 depicts a ratio of the per component carrier bandwidth over the overall sum of bandwidth of all component carriers. A UE can use the ratio to determine the weight of a particular component carrier across one or more of the deployed bands. For instance, the higher a bandwidth factor (“BWF”), the more priority the BWF has.

TABLE 1
Tuner Configuration

| CA | PCC | SCC1 | SCC2 | SCC3 |
|---|---|---|---|---|
| Bands | B2 | B13 | B41 | B41 |
| BW | 20 | 10 | 10 | 20 |
| RSRP | −90 dBm | −95 dBm | −102 dBm | −102 dBm |

TABLE 2
Bandwidth Factor

| CA | PCC | SCC1 | SCC2 | SCC3 |
|---|---|---|---|---|
| Bands | B2 | B13 | B41 | B41 |
| BWF | NA | 0.33 | NA | NA |

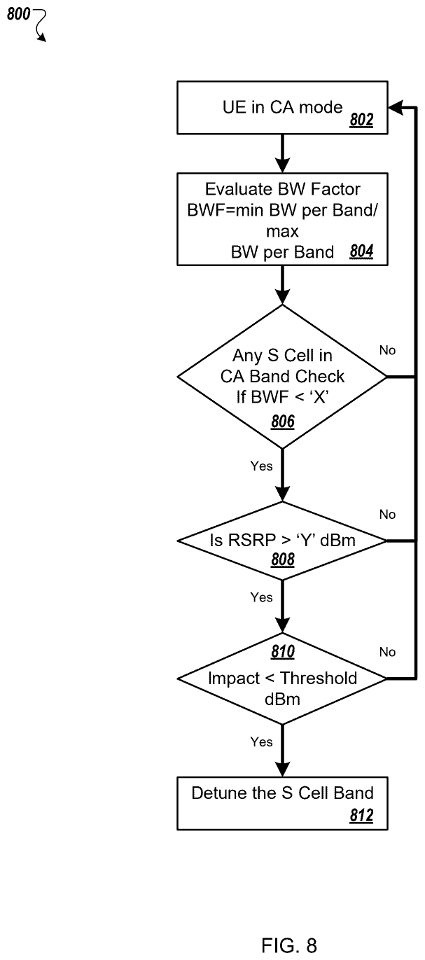

FIG. 8 depicts an example process 800 for configuring a cell band using a bandwidth factor (“BWF”). A device, such as a UE or a baseband processor (or one or more equivalent components) for a UE, can perform the operations for the process 800.

In operation 802, the UE is in CA mode. The device can determine whether the UE is in CA mode, whether to maintain CA mode, or both. In the former examples, the device can proceed to operation 804 upon determining that the device is in CA mode.

At operation 804, the device evaluates the bandwidth factor. The bandwidth factor can be any appropriate value. For instance, the device can determine the bandwidth factor that is the minimum of the BW per band, the maximum BW per band, or some other value or range.

At operation 806, the device determines whether a secondary cell in the CA band has a bandwidth factor that does not satisfy a BWF threshold X. The device can dynamically determine the BWF threshold X based at least on a performance factor, such as an application demand, a data rate demand, or both, in the UE.

At operation 808, the device determines whether the RSRP satisfies an RSRP threshold Y, e.g., the RSRP threshold described above. The RSRP threshold Y can be selected as a measured RSRP in a good to mid cell condition. In some implementations, the RSRP threshold Y can have a value in the range of, e.g., −70 dBm to −105 dBm, although different values, ranges, or both, can be used in other implementations.

At operation 810, the device determines whether an impact to a change in the band satisfies a degradation threshold, e.g., in dBm. The degradation threshold can be selected such that an impact to detuning an antenna causes the band to degrade at most an amount ranging from 0.5 dB to a maximum of 10 dB. In some implementations, other values can be used for the degradation threshold. The degradation threshold can be a value that is selected, tuned, or both, e.g., after fields tests.

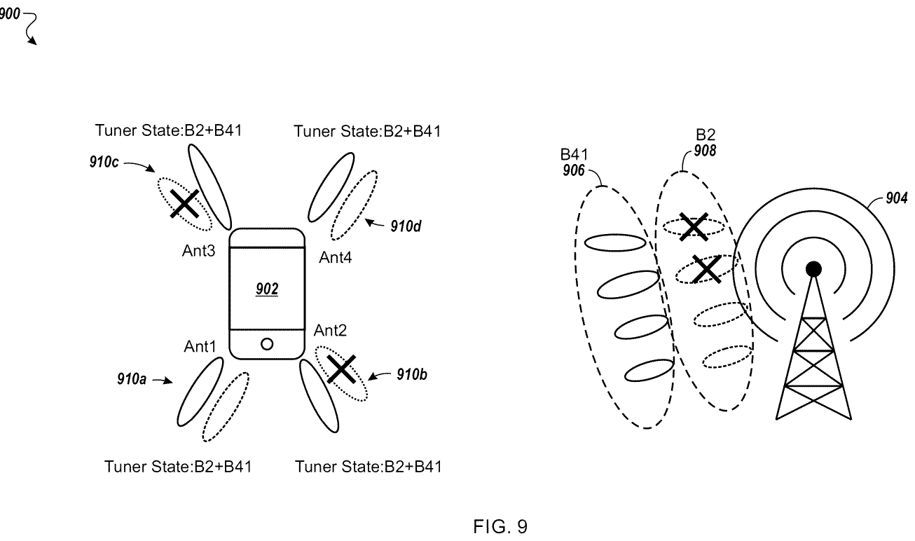

FIG. 9 depicts an example environment 900 for rank-based tuning. A UE 902 is configured with B41+B2 for communication with a base station 904. The UE 902 achieves rank R4 on band B41 906 using all antennas, and rank R2 on band B2 908 with antenna 2 and antenna 3. Because of the lower rank for band B2 908 on antennas 2-3, the UE has an RF inefficiency for band B41 906 on antennas 2-3, even when band B2 908 is not using these antennas.

For instance, each of the bands 906-908 can provide multiple layers 910 of data to the UE. Each of the UE's antennas can receive data across multiple layers. As communication conditions change, e.g., improve or degrade, or when a band doesn't support the maximum number of layers, the number of layers received for the band by a corresponding antenna can change or be limited from a maximum number of streams that can be used.

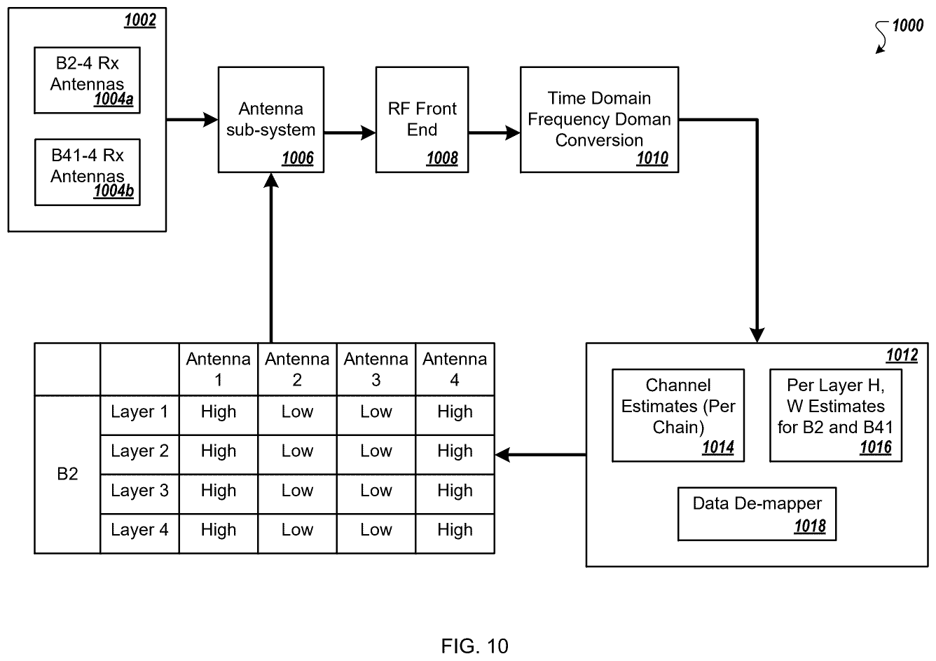

FIG. 10 depicts an example environment 1000 for UE 1002 rank-based tuner state selection. For example, to improve the RF efficiency for the UE 1002, the UE 1002 can use dynamic tuner states based at least on the ranks for the various bands.

The UE 1002 includes multiple antennas. Some of the receptions Rx for the antennas use band B2 1004a, e.g., four transmission layers. Some of the receptions Rx for the antennas use band B41 1004b, e.g., four transmission layers.

A UE can operate on multiple bands in different frequency ranges, e.g., low-band, mid-band and/or high-band. One or more of these bands can require use of different antennas for communicating with the base station than one or more other bands. The group of different antennas can collectively be called an RF antenna sub-system. The UE data can be transmitted via the RF antenna sub-system. One or more RF components can serve respective antennas in the RF antenna sub-system, forming a collection of transceivers. The one or more RF components can include, e.g., one or more low-noise amplifiers (“LNAs”), one or more filters, and one or more power amplifiers (“PAs”).

The UE 1002 can include logic 1012 for dynamically determining a tuner state based at least on an antenna rank realization. The logic 1012 can predict 1014, e.g., for one or more layers, one or more antennas, or both, a rank of achievability on a per CC basis. The logic 1012 can identify a specific antenna port, physical antenna, or both, which enables a CC to achieve the spatial diversity, e.g., rank. In some implementations, the logic 1012 can identify the antenna(s) that provide the separation in channel that allows for higher MIMO layers. In some implementations, the logic 1012 can determine 1016 a per layer H, W, or both, estimate for one or more bands, e.g., the one or more bands that have respective ranks that do not satisfy a rank criterion, e.g., bands B2 and B41 for antennas 2-3. The logic 1012 can determine to skip one or more estimates for one or more bands that satisfy the rank criteria, e.g., for bands B2 and B4 for antennas 1 and 4. The logic 1012 can include a data de-mapper 1018 that maps the antenna ports to the layer mapping, e.g., for rank estimation.

The UE 1002 can tune the specific antenna(s) to a band, band combination, or both, for which the rank satisfies the rank criterion. For instance, the UE 1002 can detune antennas 2 and 3 for band B2, for which the rank criterion is not satisfied. The UE 1002 can tune antennas 1 and 4 for bands B2 and B41, antennas 2 and 3 for band B41, or a combination thereof. By reducing the use of, e.g., detuning, the one or more bands for which the rank criterion is not satisfied, the UE can increase a data rate for the one or more bands that are used, e.g., tuned. This can increase efficiency for data communications for the UE 1002.

In some implementations, the UE 1002 can iteratively apply a prior tuner state, e.g., an original tuner state, to one or more antennas. The UE 1002 can perform this iterative process to monitor for change in one or more channel conditions, e.g., to determine whether the selected tuner state(s) are still improved or optimized for the context in which the UE is operating.

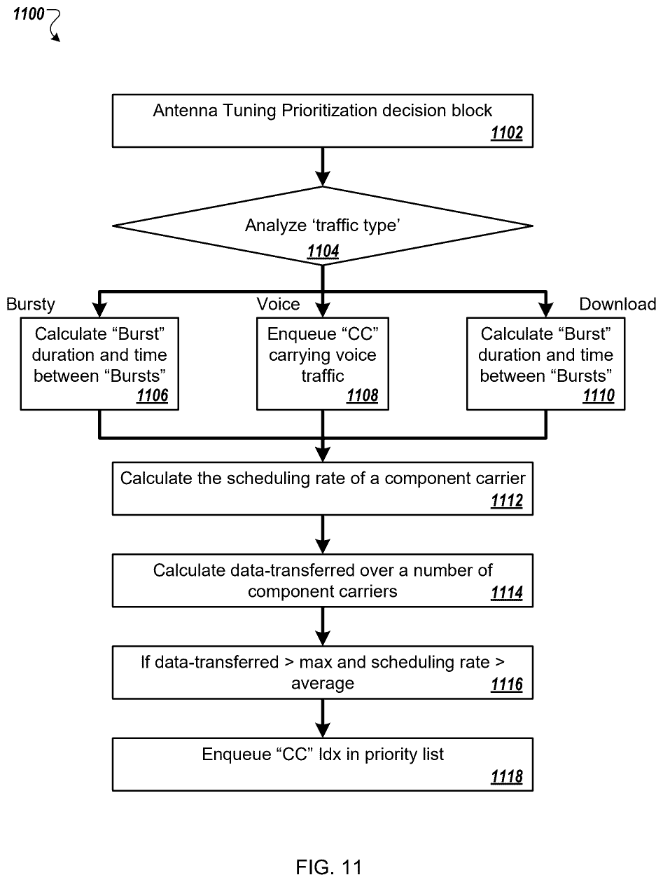

FIG. 11 depicts an example process 1100 for selecting a tuner state using network scheduling information. For instance, a network entity, e.g., base station, can configure and activate ‘n’ component carriers in an LTE, EN-DC scenario. In some implementations, not all of the CCs might be scheduled uniformly in loading conditions. For example, given some network scheduling algorithms, the base station might prioritize one band, e.g., one secondary band, over one or more other component carriers from n-number configured component carriers. The prioritized one or more bands can be bands that the network uses more frequently for scheduling than the other bands. Because the UE has a multi-carrier combination, a tuner state might be selected for the ‘n’ configured component carriers instead of being selected for the network's prioritized band. This might lead to a “poorer” RF, RSRP, or both, for a band that is highly scheduled, e.g., the prioritized band. For instance, irrespective of the scheduling load associated with an individual component carrier, the antenna tuning is configured such that all component carriers are taken into consideration, e.g., all component carriers are prioritized equally. This can occur when the antennas are tuned once, e.g., before distribution, sale, or another form of delivery of the UE, e.g., to an end user.

To improve the use of the network scheduled component carriers, the UE can dynamically change an antenna tuner state using one or more elements of network scheduling data. For instance, the UE can prioritize an individual component carrier that has a high or maximum scheduling load, e.g., to improve that component carrier's efficiency and achieve improved data throughput.

For instance, a network can utilize four bands. A first band can have a data rate per component carrier (“CC”) of 202 Mbps, a second band can have a data rate per CC of 200, and a third and a fourth band can have data rates per CC of 20. Since the latter two bands, e.g., an LTE PCell and LTE SCell, have lower data rates, instead of giving equal prioritization to each band for the tuner state, the UE, e.g., a baseband processor (or equivalent components), can prioritize one or both of the first and second bands, since they have higher data rates.

The process 1100 can be performed by any appropriate device. For instance, the process 1100 can be performed by a UE, or a component of the UE, such as a baseband processor.

At operation 1102, the device can receive data from an antenna tuning block. For instance, as described in more detail above, the device can use the antenna tuning block to determine a target frequency.

At operation 1104, the device analyzes a traffic type for data communications for the UE. The traffic type can be any appropriate type, such as bursty data, voice traffic, data download data, or any combination of these. Voice traffic data might include non-voice traffic data. Bursty data might not include voice traffic data, e.g., since the voice data requires more consistent data transfer. In some implementations, a data download can include a data download in the foreground.

At operations 1106 and 1110, the device can calculate a burst duration, a time between bursts, or both.

At operation 1108, the device can enqueue the component carrier carrying voice traffic. For instance, to maintain a quality level of the voice data, the device can determine to not degrade a quality of the component carrier for the voice traffic.

At operation 1112, the device calculates the scheduling rate of a component carrier, e.g., one or more of configured component carriers. In some implementations, the device can perform the calculation during a burst.

At operation 1114, the device calculates the data transferred over a number of component carriers. The number can be ‘n’, the total number of component carriers, for bursty data and download data. The number can be ‘n−1’, one fewer than the total number of component carriers, for voice data. The device can use ‘n−1’ since the nth component carrier will not be analyzed for degradation. In some implementations, if the performance of the nth component carrier for voice data does not satisfy a threshold, the device can analyze the data transferred for this nth component carrier.

At operation 1116, the device determines whether the data transferred satisfies a maximum data transferred threshold, whether a scheduling rate satisfies an average scheduling rate threshold, or both. The device can make the former determination for the component carriers analyzed during operation 1114, e.g., for n component carriers for bursty data and download data, and for n−1 component carriers for voice data. The device can make the latter determination for all component carriers.

At operation 1118, the device enqueues a component carrier index in a priority list. The device can use the priority list to determine the tuner state. For example, depending on the component carriers and data analyzed, the device can determine that component carrier 3 should be high priority, e.g., for bursty data and download data. In some other examples, depending on the component carriers and data analyzed, the device can determine that component carriers 1 and/or 2 should be high priority, e.g., for voice data when one of these two component carriers is used for the voice data communication.

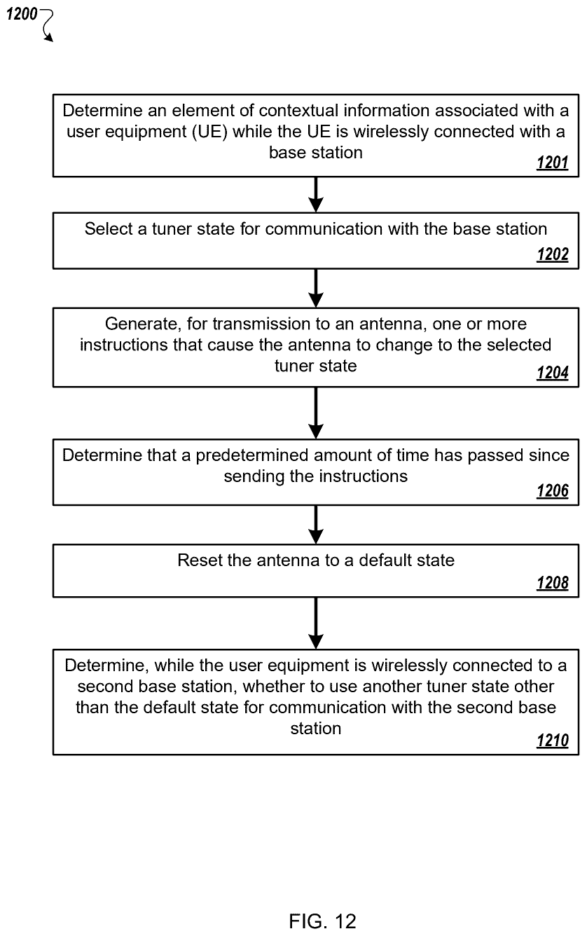

FIG. 12 illustrates a flowchart of an example method 1200 for changing an antenna tuner state. For clarity of presentation, the description that follows generally describes method 1200 in the context of the other figures in this description. For example, method 1200 can be performed by UE 102 of FIG. 1, or one or more components of the UE. It will be understood that method 1200 can be performed, for example, by any suitable system, environment, software, hardware, or any combination of systems, environments, software, and hardware, as appropriate. In some implementations, various steps of method 1200 can be run in parallel, in combination, in loops, or in any order.

A device determines an element of contextual information associated with a user equipment (UE) while the UE is wirelessly connected with a base station (1201). The element of contextual information can be any appropriate data.

The element of contextual information can include one or more of: a) data that indicates a carrier component bandwidth; b) data that indicates a scheduling rate for a communication band; c) data that indicates applications currently executing on the user equipment; d) data that indicates downlink and/or uplink communication on the user equipment; c) data that indicates whether any uplink signaling will trigger within a predetermined duration on the user equipment; f) data that indicates whether any physical downlink control channel (“PDCCH”) decode on a component carrier will begin within a predetermined duration; g) data for a radio resource control, or h) any combination of any two or more of these.

The device selects a tuner state for communication with the base station (1202). This selection can use contextual information associated with the user equipment. This selection can occur while the user equipment is wirelessly connected to a base station. The device can select the tuner state from a plurality of different tuner states.

In some implementations, this determination can include determining, for the antenna and using at least the contextual information, a target operation frequency band that has a likelihood of improving the user equipment communication that satisfies a likelihood threshold; and determining the tuner state for communication with the base station based at least on a target operation frequency.

The target operation frequency can be any appropriate type of frequency. For instance, the target operation frequency can be a single target band or can be part of a group of target bands. In some implementations, the group of target bands can have higher priority than one or more other bands. When the target operation frequency is part of a group of target bands, the tuner state can be a value that prioritizes one or more of the target bands in the group.

In some implementations, determining the target operation frequency can include providing at least the contextual information to an artificial intelligence (AI) model as input; and in response to providing at least the contextual information to the AI model as input, receiving, as output from the AI model, data that identifies a target operation frequency band that has a likelihood of improving the user equipment communication that satisfies the likelihood threshold.

When the user equipment includes more than one antenna, the device can perform one or more of these operations for one or more respective antennas. For instance, the device can determine, for at least one of the two or more antennas, a respective tuner state for communication with the base station; and send, to a respective antenna from the two or more antennas, instructions to cause the respective antenna to change to the respective tuner state while the user equipment is wirelessly connected to the base station. In some implementations, the device can determine, for at least two of the two or more antennas, a respective tuner state for communication with the base station, where at least a first tuner state for a first antenna is different than a second tuner state for a second antenna.

The device can make this determination in association with a traffic type, e.g., bursty, voice, download, or any combination of these. For instance, the device can determine, for a communication band for the antenna, a traffic type for data transmitted using the communication band; determine whether the traffic type satisfies a traffic type condition; and determine, while the user equipment is wirelessly connected to the base station, the tuner state based at least on whether the traffic type satisfies the traffic type condition.

In some implementations, the device can make this determination based on a likelihood that a change will improve throughput for the user equipment. For example, the device can determine, for a communication band for the antenna, a likelihood that changing a property of the communication band will change an efficiency of communication across the communication band; and determine, while the user equipment is wirelessly connected to the base station, the tuner state for communication with the base station using at least the likelihood that changing the property of the communication band will change the efficiency of communication across the communication band. The property can be one or more of a bandwidth for the communication band, a signal to noise ratio, or a channel quality indicator, to name a few examples. In some implementations, the efficiency can be predicted in decibels for a reference signal received power, but other measures can be used in other implementations.

In some implementations, the device can determine a likelihood that changing a property of the antenna will change an efficiency of communication across the communication band; and determine, while the user equipment is wirelessly connected to the base station, the tuner state for communication with the base station using at least the likelihood that changing the property of the antenna will change the efficiency of communication across the communication band. In some implementations, the property can be one or more of a bandwidth part for the antenna or a number of layers for the antenna. The efficiency can be predicted in decibels for a reference signal received power, and other measures can be used in some implementations.

The device generates one or more instructions that cause a change to the selected tuner state (1204). The antenna can be of the UE. The generation can occur while the UE is wirelessly connected to the base station.

The device outputs the one or more instructions that cause the change to the tuner state while the user equipment is wirelessly connected to the base station. For example, the UE can change tuner states while wirelessly connected to a base station, e.g., on one or more frequencies. This can include reconfiguring the tuner that is part of an RF chain in the UE to change tuner state change. When the base station changes a frequency of operation, the UE can change the tuner state accordingly.

The device determines that a predetermined amount of time has passed since sending the instructions (1206). The device can determine whether the tuner state should be adjusted periodically, in response to an event, or both. Sometimes, determining whether the tuner state should be adjusted can include determining whether the tuner state should be reset to a prior tuner state or to a different tuner state.

The device can reset the antenna to a default state (1208). In some implementations, the device can reset the antenna to a prior state other than the default state, e.g., the tuner state prior to the current tuner state.

In some implementations, the device can initially wirelessly connect to a first base station. The device can then wirelessly connect to a second base station, e.g., after a handover. This can occur given movement of the device in a physical region, e.g., from a first area in which the first base station provides coverage to a second area in which the second base station provides coverage.

When the user equipment is wirelessly connected to a second base station, e.g., after a handover, the device can determine whether to use another tuner state other than the default state for communication with the second base station (1210). The device can use contextual information associated with the user equipment, e.g., second contextual information, to make this determination. In some implementations, the contextual information can include one or more elements that are the same as the contextual information used for the determination at operation 1202. Additionally or alternatively, in some implementations, one or more elements of the contextual information can be different from that used at operation 1202. The contextual information can have different values and/or be of different types than that used at operation 1202. The second base station can be the same base station or a different base station than the base station described with respect to operation 1202. In some implementations, the second base station can be the same device as the base station and have a different frequency band of operation or can be a different logical base station.

The example method 1200 shown in FIG. 12 can be modified or reconfigured to include additional, fewer, or different steps (not shown in FIG. 12), which can be performed in the order shown or in a different order. In some implementations, the method 1200 can include only operations 1202 and 1204. In some implementations, the method 1200 can include only operations 1206, 1208, and 1210.

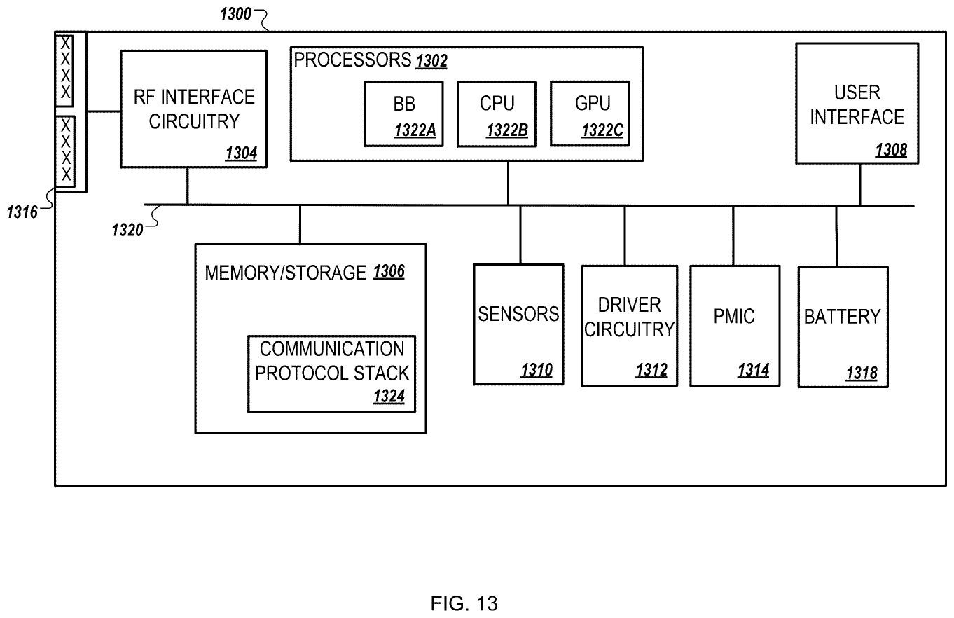

FIG. 13 illustrates an example UE 1300. The UE 1300 may be similar to and substantially interchangeable with UE 102 of FIG. 1.

The UE 1300 may be any mobile or non-mobile computing device, such as, for example, a mobile phone, computer, tablet, industrial wireless sensor (for example, microphone, pressure sensor, thermometer, motion sensor, accelerometer, inventory sensor, electric voltage/current meter, etc.), video device (for example, camera, video camera, etc.), wearable device (for example, a smart watch), relaxed-IoT device, etc.

The UE 1300 may include any/all of one or more processors 1302, RF interface circuitry 1304, memory/storage 1306, user interface 1308, sensors 1310, driver circuitry 1312, power management integrated circuit (PMIC) 1314, one or more antenna(s) 1316, and battery 1318. The components of the UE 1300 may be implemented as integrated circuits (ICs), portions thereof, discrete electronic devices, or other modules, logic, hardware, software, firmware, or any combination thereof. The block diagram of FIG. 13 is intended to show a high-level view of some of the components of the UE 1300. However, some of the components shown may be omitted, additional components may be present, and a different arrangement of the components shown may occur in other implementations.

The components of the UE 1300 may be coupled with various other components over one or more interconnects 1320, which may represent any type of interface, input/output, bus (local, system, or expansion), transmission line, trace, optical connection, etc., that allows various circuit components (on common or different chips or chipsets) to interact with one another.

The processor(s) 1302 may include processor circuitry such as, for example, baseband processor circuitry (BB) 1322A, central processor unit circuitry (CPU) 1322B, and graphics processor unit circuitry (GPU) 1322C. The processors 1302 may include any type of circuitry or processor circuitry that executes or otherwise operates computer-executable instructions, such as program code, software modules, or functional processes from memory/storage 1306 to cause the UE 1300 to perform operations as described herein.

In some implementations, the baseband processor circuitry 1322A may access a communication protocol stack 1324 in the memory/storage 1306 to communicate over a 3GPP compatible network. In general, the baseband processor circuitry 1322A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1304. The baseband processor circuitry 1322A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1306 may include one or more non-transitory, computer-readable media that includes instructions (for example, communication protocol stack 1324) that may be executed by one or more of the processors 1302 to cause the UE 1300 to perform various operations described herein. The memory/storage 1306 include any type of volatile or non-volatile memory that may be distributed throughout the UE 1300. In some implementations, some of the memory/storage 1306 may be located on the processors 1302 themselves (for example, L1 and L2 cache), while other memory/storage 1306 is external to the processors 1302 but accessible thereto via a memory interface. The memory/storage 1306 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1304 may include transceiver circuitry and radio frequency front module (RFEM) that allows the UE 1300 to communicate with other devices over a radio access network. The RF interface circuitry 1304 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1316 and proceed to filter and amplify (with a low-noise amplifier) the signal. The signal may be provided to a receiver of the transceiver that downconverts the RF signal into a baseband signal that is provided to the baseband processor of the processors 1302.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1316. In various implementations, the RF interface circuitry 1304 may be configured to transmit/receive signals in a manner compatible with NR access technologies.

The antenna(s) 1316 may include one or more antenna elements to convert electrical signals into radio waves to travel through the air and to convert received radio waves over the air into electrical signals. In some implementations, the antenna elements may be arranged into one or more antenna panels. The antenna(s) 1316 may have antenna panels that are omnidirectional, directional, or a combination thereof, to enable beamforming and multiple input, multiple output communications. The antenna(s) 1316 may include any/all of microstrip antennas, printed antennas fabricated on the surface of one or more printed circuit boards, patch antennas, phased array antennas, etc. The antenna(s) 1316 may have one or more panels designed for one or more specific frequency bands, such as bands in FR1 or FR2.

The user interface 1308 includes various input/output (I/O) devices designed to enable user interaction with the UE 1300. The user interface 1308 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1300.

The sensors 1310 may include a device, module, or subsystem whose purpose is to detect events or changes in its environment and send the information (sensor data) about the detected events to some other device, module, subsystem, etc. Examples of such a sensor include, inter alia, an inertia measurement unit including an accelerometer, gyroscope, or magnetometer; a microelectromechanical system or nanoelectromechanical system including 3-axis accelerometer, 3-axis gyroscope, or magnetometer; a level sensor; a temperature sensor (for example, thermistor); a pressure sensor; an image capture device (for example, camera or lensless aperture); a light detection and ranging sensor; a proximity sensor (for example, infrared radiation detector and the like); a depth sensor; an ambient light sensor; an ultrasonic transceiver; a microphone or other like audio capture device; etc.

The driver circuitry 1312 may include software and hardware elements that operate to control particular devices that are embedded in the UE 1300, attached to the UE 1300, or otherwise communicatively coupled with the UE 1300. The driver circuitry 1312 may include one or more individual drivers allowing other components to interact with or control various input/output (I/O) devices that may be present within, or connected to, the UE 1300. For example, driver circuitry 1312 may include a display driver to control and allow access to a display device, a touchscreen driver to control and allow access to a touchscreen interface, sensor drivers to obtain sensor readings of sensors 1310 and control and allow access to sensors 1310, drivers to obtain actuator positions of electro-mechanic components or control and allow access to the electro-mechanic components, a camera driver to control and allow access to an embedded image capture device, audio drivers to control and allow access to one or more audio devices.

The PMIC 1314 may manage power provided to various components of the UE 1300. In particular, with respect to the processors 1302, the PMIC 1314 may control power-source selection, voltage scaling, battery charging, or DC-to-DC conversion.

In some implementations, the PMIC 1314 may control, or otherwise be part of, various power saving mechanisms of the UE 1300. A battery 1318 may power the UE 1300, although in some implementations the UE 1300 may be mounted deployed in a fixed location, and may have a power supply coupled to an electrical grid. The battery 1318 may be a lithium-ion battery, a metal-air battery, such as a zinc-air battery, an aluminum-air battery, a lithium-air battery, and the like. In some implementations, such as in vehicle-based applications, the battery 1318 may be a typical lead-acid automotive battery.

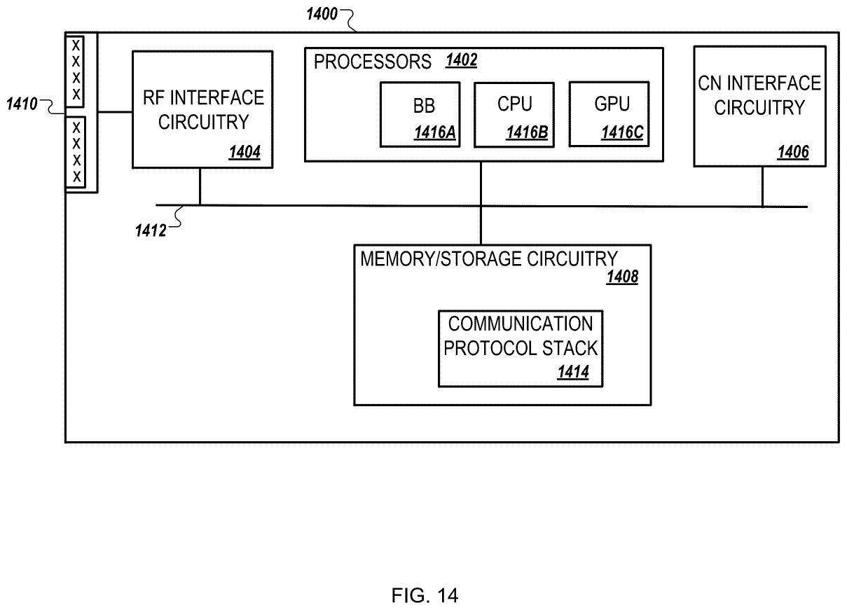

FIG. 14 illustrates an example access node 1400 (e.g., a base station or gNB). The access node 1400 may be similar to and substantially interchangeable with base station 104. The access node 1400 may include processors 1402, RF interface circuitry 1404, core network (CN) interface circuitry 1406, memory/storage circuitry 1408, and one or more antenna(s) 1410.

The components of the access node 1400 may be coupled with various other components over one or more interconnects 1412. The processors 1402, RF interface circuitry 1404, memory/storage circuitry 1408 (including communication protocol stack 1414), antenna(s) 1410, and interconnects 1412 may be similar to like-named elements shown and described with respect to FIG. 13. For example, the processors 1402 may include processor circuitry such as, for example, baseband processor circuitry (BB) 1416A, central processor unit circuitry (CPU) 1416B, and graphics processor unit circuitry (GPU) 1416C.

The CN interface circuitry 1406 may provide connectivity to a core network, for example, a 5th Generation Core network (5 GC) using a 5GC-compatible network interface protocol such as carrier Ethernet protocols, or some other suitable protocol. Network connectivity may be provided to/from the access node 1400 via a fiber optic or wireless backhaul. The CN interface circuitry 1406 may include one or more dedicated processors or FPGAs to communicate using one or more of the aforementioned protocols. In some implementations, the CN interface circuitry 1406 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, cNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1400 that operates in an NR or 5G system (for example, a gNB), and the term “E-UTRAN node” or the like may refer to an access node 1400 that operates in an LTE or 4G system (e.g., an eNB). According to various implementations, the access node 1400 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1400 may be implemented as one or more software entities running on server computers as part of a virtual network, which may be referred to as a CRAN and/or a virtual baseband unit pool (vBBUP). In V2X scenarios, the access node 1400 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some implementations, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

We claim:

1. A method comprising:
determining an element of contextual information associated with a user equipment (UE) while the UE is wirelessly connected with a base station;
selecting a first tuner state based at least on the element of contextual information; and
generating one or more instructions that cause a change to the first tuner state of a first antenna of the UE while the UE is wirelessly connected to the base station.

2. The method of claim 1, wherein selecting the first tuner state comprises:
determining, for the first antenna and using the element of contextual information, a target operation frequency band having a likelihood of improving an aspect of communication for the UE that satisfies a likelihood threshold; and
identifying the first tuner state based at least on the target operation frequency band.

3. The method of claim 2, wherein determining the target operation frequency band comprises:
providing at least the element of contextual information to an artificial intelligence (AI) model as input; and
receiving, from the AI model, an indication of the target operation frequency band having the likelihood of improving the aspect of communication for the UE that satisfies the likelihood threshold.

4. The method of claim 1, wherein:
the UE comprises at least a second antenna separate from the first antenna; and
the method further comprises:
determining, for the second antenna, a respective second tuner state for communication with the base station; and
generating instructions to cause the second antenna to change to the respective second tuner state while the UE is wirelessly connected to the base station.

5. The method of claim 4, wherein the respective second tuner state for the second antenna differs from the first tuner state for the first antenna.

6. The method of claim 1, wherein selecting the first tuner state comprises:
determining, for a communication band associated with the first antenna, a traffic type corresponding to data transmitted using the communication band;
determining whether the traffic type satisfies a traffic type condition; and
identifying, while the UE is wirelessly connected to the base station, the first tuner state based at least on whether the traffic type satisfies the traffic type condition.

7. The method of claim 1, wherein selecting the first tuner state comprises:
determining, for a communication band associated with the first antenna, a likelihood that changing a property of the communication band will change an efficiency of communication using the communication band; and
identifying, while the UE is wirelessly connected to the base station, the first tuner state based at least on the likelihood that changing the property of the communication band will change the efficiency of communication using the communication band.

8. The method of claim 7, wherein:
the property of the communication band comprises at least one of a bandwidth of the communication band, a signal to noise ratio associated with the communication band, or a channel quality indicator associated with the communication band.

9. The method of claim 7, wherein selecting the first tuner state comprises:
determining a likelihood that changing a property of the first antenna will change an efficiency of communication using the communication band; and
identifying the first tuner state for communication with the base station based at least on the likelihood that changing the property of the first antenna will change the efficiency of communication using the communication band exceeding a likelihood threshold.

10. The method of claim 9, wherein:
the property comprises at least one of a bandwidth part associated with the first antenna or a number of layers associated with the first antenna; and
the efficiency is predicted in decibels for a reference signal received power.

11. The method of claim 1, wherein selecting the first tuner state is based at least on data indicating:
a carrier component bandwidth;
a scheduling rate associated with a communication band;
an application currently executing on the UE;
downlink and/or uplink communication occurring at the UE;
whether uplink signaling will begin on the UE within a threshold period of time;
whether a physical downlink control channel (“PDCCH”) decode associated with a component carrier will begin within a threshold period of time; or
a radio resource control.

12. The method of claim 1, further comprising:
determining that a predetermined amount of time has passed since sending the instructions to the first antenna; and
resetting the first antenna to a default state.

13. The method of claim 12, further comprising:
determining, using at least second contextual information for the UE and while the UE is wirelessly connected to a second base station, whether to use another tuner state other than the default state for communication with the second base station.

14. The method of claim 1, wherein selecting the first tuner state comprises selecting, by a baseband processor, the first tuner state.

15. One or more baseband processors and memory storing instructions that are operable, when executed by the one or more baseband processors, to cause the one or more baseband processors to perform operations comprising:
determining an element of contextual information associated with a user equipment (UE) while the UE is wirelessly connected with a base station;
selecting a first tuner state based at least on the element of contextual information; and
generating one or more instructions that cause a change to the first tuner state of a first antenna of the UE while the UE is wirelessly connected to the base station.

16. The one or more baseband processors of claim 15, wherein selecting the first tuner state comprises:
determining, for the first antenna and using the element of contextual information, a target operation frequency band having a likelihood of improving an aspect of communication for the UE that satisfies a likelihood threshold; and
identifying the first tuner state based at least on the target operation frequency band.

17. The one or more baseband processors of claim 16, wherein determining the target operation frequency band comprises:
providing at least the element of contextual information to an artificial intelligence (AI) model as input; and
receiving, from the AI model, an indication of the target operation frequency band having the likelihood of improving the aspect of communication for the UE that satisfies the likelihood threshold.

18. The one or more baseband processors of claim 15, wherein:
the UE comprises at least a second antenna separate from the first antenna; and
the operations further comprises:
determining, for the second antenna, a respective second tuner state for communication with the base station; and
generating instructions to cause the second antenna to change to the respective second tuner state while the UE is wirelessly connected to the base station.

19. The one or more baseband processors of claim 18, wherein the respective second tuner state for the second antenna differs from the first tuner state for the first antenna.

20. A system comprising:
a first antenna; and
one or more baseband processors and memory storing instructions that are operable, when executed by the one or more baseband processors, to cause the one or more baseband processors to perform operations comprising:
determining an element of contextual information associated with a user equipment (UE) while the UE is wirelessly connected with a base station;
selecting a first tuner state based at least on the element of contextual information; and
generating one or more instructions that cause a change to the first tuner state of the first antenna of the UE while the UE is wirelessly connected to the base station.
